(19) United States
(12) Patent Application Publication
(10) Pub. No.: US 2007/0189338 A1
(43) Pub. Date: Aug. 16, 2007

(54) White light solid-state laser source

(76) Inventors: Wolf Seelert, Lubeck (DE); Andreas Diening, Lubeck (DE)

Correspondence Address: STALLMAN & POLLOCK LLP, 353 SACRAMENTO STREET, SUITE 2200, SAN FRANCISCO, CA, 94111, US

(21) Appl. No.: 11/353,320

(22) Filed: Feb. 14, 2006

(51) Int. Cl. H01S 3/30; H01S 3/10

(52) U.S. Cl. 372/6; 372/22

(57) ABSTRACT

Red light and green light are generated by passing a beam of plane-polarized blue light sequentially through two resonators each including a praseodymium-doped gain medium. A portion of the blue light is absorbed in the gain media and optically pumps the gain-media. Green light is generated in the first resonator and red light is generated in the second resonator. Green light from the first resonator is transmitted through the second resonator. Red light, green light, and unabsorbed blue light are delivered from the second resonator. Relative proportions of red light, green light, and blue light delivered from the second resonator can be varied by varying the orientation of the polarization-plane of the blue light with respect to the gain media. Sources of plane polarized blue light include optically pumped, frequency-doubled edge-emitting and surface-emitting semiconductor lasers.

### TECHNICAL FIELD OF THE INVENTION

The present invention relates in general to generating diode-laser pumped, solid-state lasers. The invention relates in particular to generating red and green laser radiation from a solid-state gain-medium optically pumped by radiation from a diode-laser emitting blue radiation.

### DISCUSSION OF BACKGROUND ART

It is well known that visible laser radiation having a particular color can be provided by combining red, green, and blue laser beams. The range of colors that can be provided depends, among other factors, on the actual wavelengths of the red (R), green (G), and blue (B) beams and the relative intensity of the red, green, and blue beams. In one particular combination, the red, green and blue beams can be combined to provide a beam of white light. One combination of wavelengths that can provide an adequate range of colors, and a neutral white, is a blue wavelength of about 460 (nm), a green wavelength of about 530 nm, and a red wavelength of about 640 nm. It would be advantageous to provide light of about these wavelengths from a single, semiconductor-laser pumped, compact laser apparatus. It would be particularly advantageous if such a source could be provided with adjustable R, G, & B output.

### SUMMARY OF THE INVENTION

The present invention is directed to providing red, green, and blue light from a laser apparatus optically pumped by the blue light. In one aspect, the method comprises providing a beam of plane-polarized blue light. A first praseodymium-doped crystal gain-medium is optically pumped with a first portion of the blue light. The first gain-medium is located in a first resonator arranged to deliver green light. The amount of green light delivered depends on the orientation the polarization plane of the first portion of the blue light with respect to the first gain medium. A second praseodymium-doped crystal gain-medium is optically pumped with a second portion of the blue light. The second gain-medium is located in a second resonator arranged to deliver red light. The amount of red light delivered depends on the orientation the polarization plane of the second portion of the blue light with respect to the second gain medium. The polarization plane of at least one of the first portion of the blue light with respect to the first gain-medium and the second portion of the blue light with respect to said second gain-medium is adjusted to adjust relative portions of red and green light delivered. A third portion of the blue light can be combined with the red and green light to provide white light, or light of a particular non-white color, depending on the relative proportions of the red light, the green light, and the blue-light that are combined.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain principles of the present invention.

FIG. 1 schematically illustrates one preferred embodiment of red, green, and blue laser apparatus in accordance with the present invention, including a semiconductor laser delivering a beam of plane-polarized blue light, with first and second monolithic Pr³⁺:YLF resonators sequentially optically pumped by the beam of blue light, the laser output of the apparatus comprising a portion of the blue light transmitted through the first and second resonators, green light delivered by the first resonator and transmitted through the second resonator, and red light delivered by the second resonator, selectively rotatable polarization rotators being provided for adjusting the amount of blue light pumping, and accordingly red light and green light delivery by the first and second resonators.

FIG. 1A schematically illustrates one alternative embodiment of red, green, and blue laser apparatus in accordance with the present invention, similar to the apparatus of FIG. 1 but wherein the polarization rotators are omitted and gain crystals in the resonators are selectively rotatable with respect to the polarization plane of the blue light for adjusting the amount of blue light pumping, and accordingly red light and green light delivery by the first and second resonators.

FIG. 2 is a graph schematically illustrating absorption as a function of wavelength in a Pr³⁺:YLF crystal for two polarizations orthogonally oriented with respect to the c-axis of the Pr³⁺:YLF crystal.

FIG. 3 is a graph schematically illustrating emission cross-section as a function of wavelength in a Pr³⁺:YLF crystal for the two polarizations of FIG. 2.

FIG. 4 schematically illustrates another preferred embodiment of red, green, and blue laser apparatus in accordance with the present invention, the apparatus having the optical pumping and light-generating sequence of the laser of FIG. 1, but wherein the first and second resonators each include a pair of resonator mirrors with a Pr³⁺:YLF crystal therebetween and separate from the mirrors, and wherein the semiconductor laser is a frequency-doubled, external-cavity, surface-emitting semiconductor laser.

FIG. 5 schematically illustrates yet another preferred embodiment of red, green, and blue laser apparatus in accordance with the present invention, the apparatus having the optical pumping and light-generating sequence of the laser of FIG. 1, but wherein the first and second laser-resonators are Pr³⁺ doped fiber laser-resonators formed between Bragg gratings in a length of optical fiber and wherein the semiconductor laser is a frequency-doubled diode-laser having a blue-light output.

FIG. 6 schematically illustrates still another preferred embodiment of red, green, and blue laser apparatus in accordance with the present invention, including first and second Pr³⁺ doped fiber laser-resonators similar to the laser-resonators of FIG. 5, but wherein the laser-resonators are optically pumped in parallel by blue light from a frequency-doubled diode-laser.

### DETAILED DESCRIPTION OF THE INVENTION

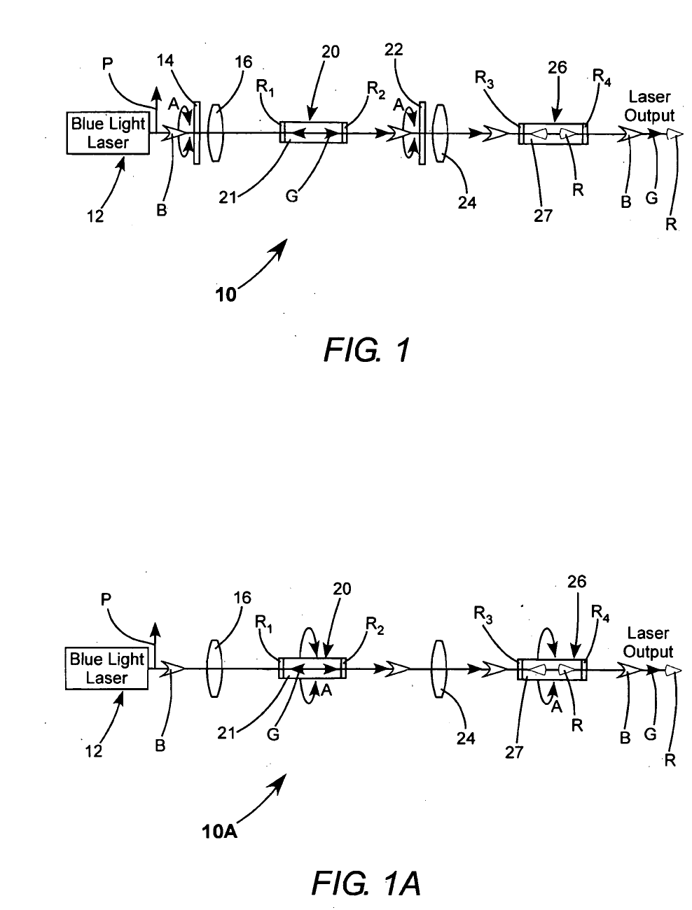

Referring now to the drawings, wherein like components are designated by like reference numerals, FIG. 1 schematically illustrates one preferred embodiment 10 of laser apparatus in accordance with the present invention. Laser 10 includes a laser 12 arranged to deliver blue light, indicated by large open arrowhead B. Laser 12 is preferably a semiconductor laser.

One example of a suitable semiconductor laser is an electrically pumped semiconductor laser having an active layer of gallium nitride (GaN) indium gallium nitride (InₓGa₍₁₋ₓ₎N), indium gallium nitride arsenide (InₓGa₍₁₋ₓ₎NyAs_{(1-y)}) or gallium nitride arsenide (GaN_{y}As_{(1-y)}). Another example of a suitable semiconductor laser is a frequency-doubled diode-laser such as an externally frequency-doubled single-mode edge-emitting laser. Such a laser having plane-polarized, single-mode, blue-light output is commercially available from Picarro Inc., of San Jose, Calif.

Yet another example of a suitable semiconductor laser is an optically pumped (semiconductor-laser pumped), external-cavity, intra-cavity frequency-doubled, surface-emitting semiconductor laser. Such a laser is referred to hereinafter simply as a frequency-doubled OPS laser. A surface-emitting heterostructure of such a laser includes a gain-structure having active layers separated by half-wavelengths of the emission wavelength by one or more separator layers. In one example of such a structure, active layers of InₓGa₍₁₋ₓ₎As, can provide an emission (fundamental) wavelength of about 958 nm, which can be intra-cavity frequency doubled to provide an output wavelength of 479 nm. Frequency-doubled OPS-lasers having plane-polarized blue-light output are commercially available from Coherent Inc. of Santa Clara, Calif., the assignee of the present invention.

Other blue-light lasers suitable for use include, but are not limited to, OPS-lasers having a fundamental blue-light output and optically pumped edge-emitting semiconductor lasers having fundamental blue-light output. Examples of fundamental blue-light OPS-lasers are described in detail in U.S. application Ser. No. 10/961,262, filed Oct. 8, 2004 and in U.S. patent application Ser. No. 11/203,734, filed Aug. 15, 2005, assigned to the assignee of the present invention, and the complete disclosure of each of which are hereby incorporated by reference. Examples of fundamental-output, optically pumped, edge-emitting semiconductor lasers are described in U.S. Patent Application No. 2005/0276301, also assigned to the assignee of the present invention, and the complete disclosure of which is also hereby incorporated by reference.

Blue-light output of laser 12 is preferably plane-polarized, for reasons which are discussed further herein below. The polarization vector (electric vector) of light leaving laser 12 is indicated here as being (arbitrarily) in the plane of the drawing. The plane-polarized blue light is passed through a polarization rotator 14, which is arranged to selectively rotate the polarization plane of the blue light by rotating the polarizer about an axis parallel to the propagation direction of the blue light as indicated by arrow A. After traversing polarization rotator 14, the blue light is focused by a lens 16 into a monolithic laser resonator 20. Resonator 20 is formed by a crystal 21 of a gain-medium having a wavelength-selective (multilayer-dielectric) reflector R₁ on one end thereof and a wavelength-selective reflector R₂ on an opposite end thereof. Preferably crystal 21 is a fluoride or oxide crystal doped with trivalent praseodymium (Pr³⁺). One preferred crystal material is praseodymium-doped yttrium lithium fluoride (Pr³⁺:YLF). Other preferred Pr³⁺ doped crystal materials include yttrium aluminum oxides (Pr³⁺:Y₃Al₅O₁₂ and Pr³⁺:YAlO₃), barium yttrium fluoride (Pr³⁺:BaY₂F₈), lanthanum fluoride (Pr³⁺:LaF₃), calcium tungstate (Pr³⁺:CaWO₄), strontium molybdate (Pr³⁺:SrMoO₄), yttrium aluminum garnet (Pr³⁺:YAG), yttrium silicate (Pr³⁺:Y₂ SiO₅), yttrium phosphate (Pr³⁺:YP₅O₁₄), lanthanum phosphate (Pr³⁺:LaP₅O₁₄), lutetium aluminum oxide (Pr³⁺:LuAlO₃), lanthanum chloride (Pr³⁺:LaCl₃), lanthanum bromide (Pr³⁺:LaBr₃). Crystals may also include rare-earth dopants in addition to praseodymium. Such additional dopants include erbium (Er³⁺), holmium (Ho³⁺), dysprosium (Dy³⁺), europium (Eu³⁺), samarium (Sm³⁺), promethium (Pm³⁺), neodymium (Nd³⁺), and ytterbium (Yb³⁺).

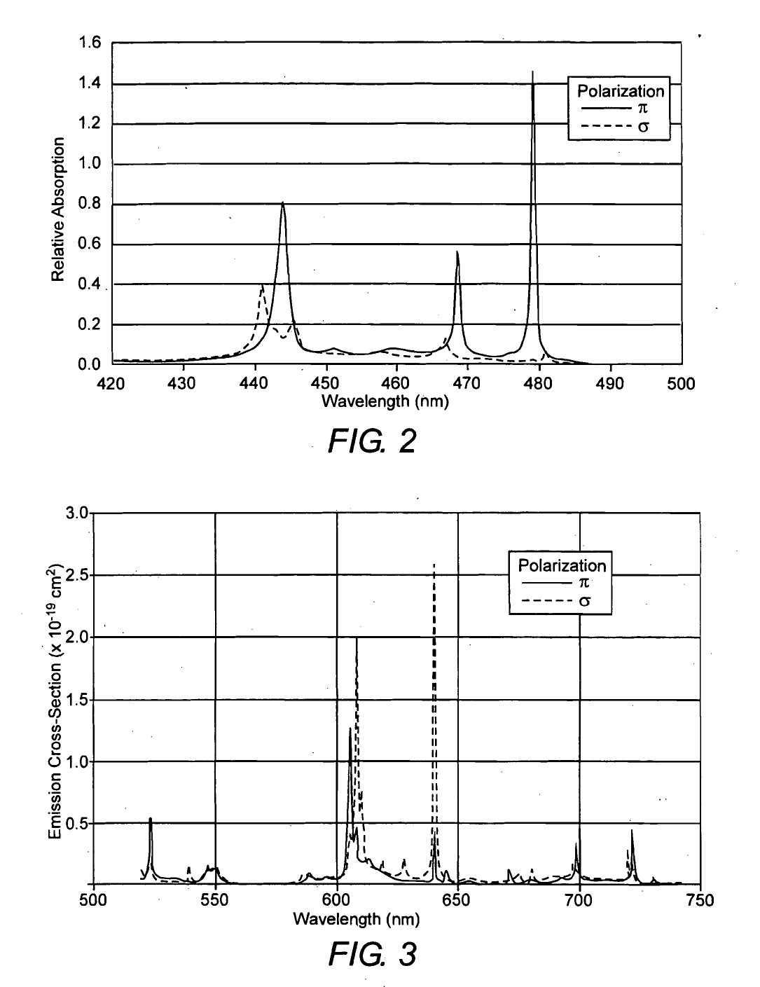

Pr³⁺:YLF has a polarization-dependent absorption spectrum including absorption peaks, for one polarization orientation, at wavelengths of about 444 nm, about 468 nm, and about 479 nm, with weaker absorption peaks for an orthogonally oriented polarization at about 440 nm, about 445 nm, about 451 nm, about 460 nm, and about 467 nm. Any of these wavelengths would be useful as blue light for combination with red light and green light to form white light, or light of a selected color (hue, saturation and brightness). FIG. 2 schematically illustrates the absorption spectra for Pr³⁺:YLF in the two different polarization orientations, in a wavelength range between about 420 nm and 500 nm. A solid curve depicts the absorption spectrum for the spectrum for a polarization orientation wherein the electric vector is oriented parallel to the crystal c-axis (π-orientation), with a dashed curve depicting the spectrum for light with the electric vector oriented perpendicular to the crystal c-axis (σ-orientation). The strong absorption peak at 479 nm makes this wavelength a preferred wavelength for pumping. FIG. 3 schematically illustrates emission cross-section spectra for Pr³⁺:YLF for the polarization orientations of FIG. 2.

Referring again to FIG. 1, preferably resonator 20 is arranged to generate green light (indicated by solid arrowheads G), responsive to absorption of a portion of the blue light by gain-medium (crystal) 21. Pr³⁺:YLF has a laser transitions (emission wavelengths) at about 522 nm and about 545 nm in the green region of the visible spectrum (see FIG. 3). The 522 nm wavelength is preferred. Layers of reflector R₁, in such a resonator arrangement for generating 522 nm radiation, would be selected to provide maximum reflection, for example, greater than about 99.8% reflection, at the 522 nm wavelength, and maximum transmission for the blue-light wavelength. Layers of reflector R₂ would be selected to provide about 98% reflection and about 2% transmission at the 522 nm wavelength, and maximum transmission for the blue-light wavelength. The naturally higher emission cross-section of the 522 nm transition compared with that of the 545 nm transition will provide that the 522 nm is generated preferentially.

Green light and unabsorbed blue light are delivered from resonator 20 via reflector R₂. The green and blue light pass through another polarization rotator 22 which is also arranged to selectively rotate the polarization plane of the blue light. After traversing polarization rotator 22, the blue light and green light are focused by a lens 24 into a monolithic laser resonator 26. Resonator 26 is formed by a crystal 27 of a gain medium having a wavelength-selective (multilayer-dielectric) reflector R₃ on one end thereof and a wavelength-selective reflector R₄ on an opposite end thereof. Preferably crystal 27 is also a fluoride or oxide crystal doped with trivalent praseodymium (Pr³⁺), for example, Pr³⁺:YLF as discussed above.

Resonator 26 is arranged to generate red light (indicated in FIG. 1 by small open arrowheads R), responsive to absorption of a portion of the blue light by gain-medium (crystal) 27. Pr³⁺:YLF has a laser transition (emission wavelength) at about 639.5 nm in the red region of the visible spectrum (see FIG. 3). Layers of reflector R₃, in such a resonator arrangement for generating 639.5 run radiation, would be selected to provide maximum reflection at the 639.5 nm wavelength, and maximum transmission for the blue-light and green-light wavelengths. Layers of reflector R₄ would be selected to provide about 98% reflection and about 2% transmission at the 639 nm. wavelength, and maximum transmission for the blue-light and green-light wavelengths. If desired, the resonator could be configured to generate an output at 644 nm instead of 639.5 nm.

Green light, red light, and unabsorbed blue light are delivered from resonator 20 via reflector R₄ as output of the laser apparatus. The relative powers of the red light, green light, and blue light delivered by the inventive laser will depend, among other factors, on the blue-light wavelength selected, the dopant percentage in gain media 21 and 27, the length of the gain-media, and the polarization orientation of the blue light with respect to the gain-media. The polarization orientation of the light entering the gain-media can be adjusted by selectively rotating optional polarization rotators 14 and 22 about an axis parallel to the propagation direction of the blue light. Alternatively, (see apparatus 10A in FIG. 1A), the polarization rotators may be omitted, and the individual crystals 21 and 27 can be selectively rotated about the propagation direction (resonator axis) to adjust the polarization orientation of the blue light relative to the crystal. Either method of adjusting polarization orientation can be used to vary proportions of red light, green light, and blue light in the laser output. This is useful either for providing an output of a desired color or for adjusting “white balance” when a neutral white light output is desired. Methods and mechanisms for rotating the polarization rotators are well-known in the art and a detailed description thereof is not necessary for understanding principles of the present invention. Accordingly, such a detailed description is not presented herein.

It should be noted, here, that while apparatus 10 is described as delivering red light, green light, and blue light as laser output propagating along a common path, the laser output may also be divided into separate red, green and blue channels by appropriate dichroic beam-splitters as is known in the art. In this way each color could be individually modulated by means of a modulator, for example, an acousto-optic modulator (AOM), an electro-optic modulator, or an interferometric monitor such as a Mach-Zehnder inteferometer. Further, while the resonators 20 and 26 are described as first generating green light then generating red light, the resonators may be arranged, by suitable selection of transmission and reflection values for reflectors R₁, R₂, R₃, and R₄, to first generate red light and then generate green light. Generating green light first is preferred because the gain at 522 nm for Pr3+:YLF is significantly lower than that at 639.5 nm.

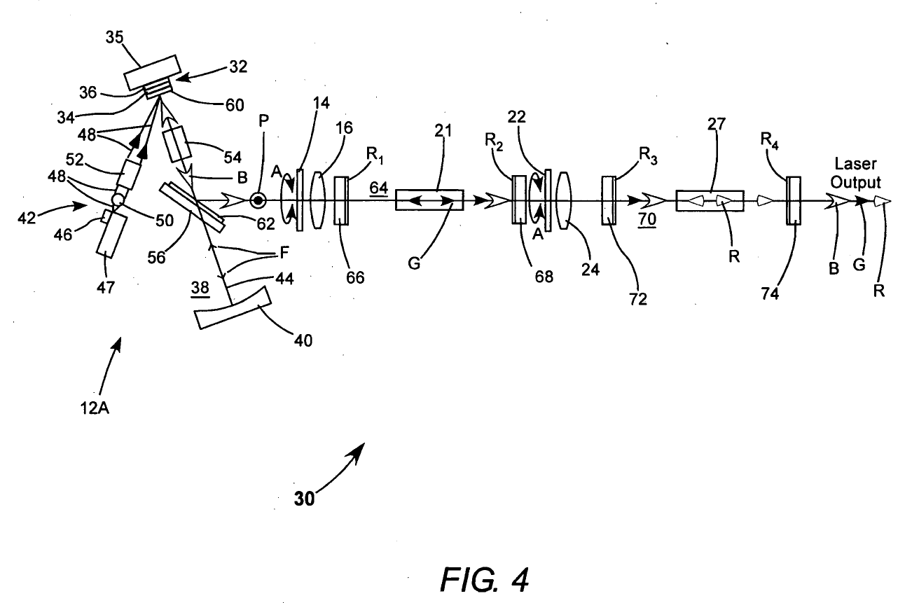

FIG. 4 schematically illustrates another embodiment 30 of laser apparatus in accordance with the present invention. In apparatus 30, blue-light laser 12A is an example of a frequency-doubled OPS laser of the type discussed above. Laser 12A includes an optically-pumped semiconductor laser structure (OPS-structure) 32 including an epitaxially-grown monolithic semiconductor (surface-emitting) gain-structure 34 including a plurality of active layers (not shown) spaced apart by separator-layers (not shown). The gain structure surmounts a Bragg mirror structure 36. OPS-structure 32 is in thermal contact with a substrate or heat-sink 35 via the Bragg mirror-structure.

Gain-structure 34, on being optically pumped, emits laser-radiation in a narrow spectrum of wavelengths, generally defined as a gain-bandwidth of the gain-structure. The gain-bandwidth has a nominal (median) characteristic (fundamental) emission wavelength and corresponding characteristic emission frequency which is dependent, inter alia, on the composition of the active layers. By way of example, for active layers of an InₓGa₍₁₋ₓ₎As_{y}P_{(1-y)} composition emission wavelengths between about 700 and 1100 nm can be achieved by selection of appropriate proportions for x and y. The fundamental wavelength selected should be twice the desired wavelength of the blue light. OPS structures having emission wavelengths in this range are available from Coherent Tutcore OY, of Tampere Finland.

Mirror structure 36 serves as one end-mirror (a plane mirror) for a laser-resonator 38. Another mirror 40, preferably a concave mirror, provides the other end-mirror of laser-resonator 38. Gain-structure 34 of OPS-structure 32 is thereby incorporated in laser-resonator 38. Mirror structure 34 and mirror 40 are highly reflective (for example have a reflectivity of about 99% or greater) for the fundamental (emission) wavelength of gain-structure 34.

A pump-radiation source 42 is arranged to deliver pump-radiation to gain-structure 34 of OPS-structure 32 for generating laser-radiation in laser-resonator 38. Fundamental radiation so generated circulates in laser-resonator 38 generally along resonator axis 44, as indicated by single arrowheads F. Pump-radiation source 42 includes an edge-emitting semiconductor diode-laser 46 or an array of such lasers mounted on a heat sink 47. Pump-light 48 exits diode-laser 46 as a divergent beam and is focused onto OPS-structure 32 by a cylindrical microlens 50 and a radial-gradient-index lens (a SELFOC lens) 52.

An optically-nonlinear crystal 54, arranged for type-I phase-matching, is located in laser-resonator 38 and arranged to double the frequency (half the wavelength) of the fundamental laser-radiation to generate blue light. The axial path of the blue light is indicated in FIG. 3 by large open arrowheads B.

A birefringent filter 56 is located in laser-resonator 38 for selecting the fundamental of the laser-radiation from a gain bandwidth of wavelengths characteristic of the composition of the active layers. The birefringent filter is inclined at an angle (preferably Brewster's angle for the material of the filter) to resonator axis 44, and serves additionally to cause fundamental radiation in the resonator and blue light generated by optically nonlinear crystal 56 to be plane polarized.

OPS-structure 32 has a multilayer optical coating 60 thereon. Coating 60 is highly reflective for blue-light B and highly transmissive for fundamental laser-radiation F and pump-light 48. Optical coating 60 minimizes absorption of second-harmonic radiation in OPS-structure 32 and reflects this second-harmonic radiation back along axis 44 toward birefringent filter 56. Birefringent filter 56 has a coating 62 thereon on a side thereof facing OPS-structure 32. Coating 62 is highly reflective for blue light B in the s-state of polarization, and is highly transmissive for fundamental laser-radiation F in the p-state of polarization. Dichroic coating 62 directs blue-light B out of laser-resonator 38 and prevents significant loss of the 2H-radiation in the birefringent filter. The electric vector of light B is perpendicular to the plane of the drawing as indicated by arrowhead P.

Plane-polarized blue-light output of laser is passed through a polarization rotator 14 and is focused by a lens 16 into a gain medium (crystal) 21 located in a laser resonator 64. Resonator 64 is formed between reflectors R₁ and R₂ supported on substrates 66 and 68 respectively. Reflectors R1 and R2 have the specifications discussed above with respect to FIG. 1 and green light is generated in resonator 64.

Green light and unabsorbed blue light are delivered from resonator 64 via reflector R₂. The green and blue light pass through another polarization rotator 22 which is also arranged to selectively rotate the polarization plane of the blue light. The green light and blue light are focused by lens 24 into a gain medium (crystal) 27 located in a resonator 70. Resonator 70 is formed between reflectors R₃ and R₄ on substrates 72 and 74, respectively. Reflectors R₃ and R₄ have specifications as discussed above and resonator 70 generates red light responsive to absorption of the blue light in gain medium 27. Green light, red light, and unabsorbed blue light are delivered from resonator 20 via reflector R₄ as output of the laser apparatus. The relative powers of the red light, green light, and blue light delivered by the inventive laser can be varied by varying the polarization orientation of blue light in the gain-media, as discussed above for providing an output of a desired color or for adjusting “white balance” when a neutral white light output is desired.

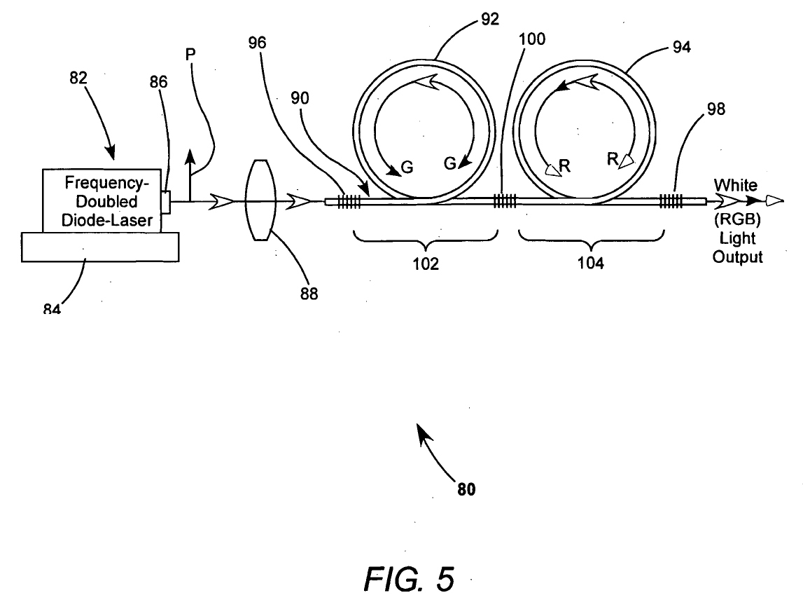

FIG. 5 schematically illustrates yet another embodiment 80 of red, green, and blue laser apparatus in accordance with the present invention. In this embodiment blue light is provided by frequency-doubled diode-laser (edge-emitting semiconductor laser) 82 mounted on a heat-sink 84. Blue-light output from a port 86 of laser 82 is focused by a lens 88 into the core of a length 90 optical fiber having a Pr³⁺-doped core Preferably the optical fiber is low-phonon fiber having a single-mode core. One suitable fiber is a Pr³⁺-doped ZBLAN fiber. ZBLAN is a glass comprising a mixture of zirconium, barium, lanthium, aluminum and sodium flourides. The Pr³⁺-doped core of the fiber may be co-doped with any of the co-dopants listed above with reference to crystal gain-media.

The fiber is formed into two coils 92 and 94 each coil preferably including between about 0.5 and 5.0 meters of fiber. The length of fiber has fiber Bragg grating (FBG) 96 written into the core at a proximal end thereof and a FBG 98 written into the core at a distal end thereof. Yet another FBG 100 is written is into the fiber length between coils 92 and 94. FBGs 96 and 100 serve as end reflectors for a first fiber laser-resonator 102. FBGs 100 and 98 serve as resonator reflectors for a second fiber laser-resonator 104. The first and second fiber laser-resonator are pumped by respectively first and second portions of the blue light focused into the fiber by lens 88. A remaining third portion of the blue light is delivered from the distal end of the fiber length.

In the example of apparatus 80 depicted in FIG. 8, the FBGs are configured such that laser 102 generates green light and laser 104 generates red light in response to optical pumping by the blue light. In this case all FBGs have maximum possible transmission for the wavelength of the blue pump light. FBG 96 has maximum reflectivity, for example, greater than about 99% reflectivity, for 522 nm-radiation. FBG 100 is partially reflective and partially transmissive for 522 nm-radiation, for example, about 98% reflective and about 2% transmissive. FBG 100 is also maximally reflective for 639 nm-radiation. FBG 98 is partially reflective and partially transmissive for 639 nm-radiation, for example, about 95% reflective and about 5% transmissive. FBG 98 is also as transmissive as possible for blue light and the 522 nm-radiation.

It should be noted here that the terminology “length of optical fiber” used herein with respect to optical fiber length 90 should not be construed as meaning that the length is an “as-drawn” length. Various lengths of fiber may be spliced together to form the total length of fiber 90, and certain lengths need not have a doped core. By way of example, short lengths of fiber having an un-doped core may be used at the input and output (proximal and distal) ends of the fiber length and between the coils 92 and 94 of doped fiber that provide gain for the laser-resonators.

An advantage of laser apparatus 80 compared with other above-described embodiments of the present invention is that the apparatus has a minimum of optical components and can be made very rugged. A disadvantage of apparatus 80 compared with other above-described embodiments of the present invention is that since the gain of the Pr³⁺-doped optical fibers is not polarization sensitive, there is no efficient way of varying the R, G, and B content of the apparatus for adjusting white balance or adjusting the color of the output light.

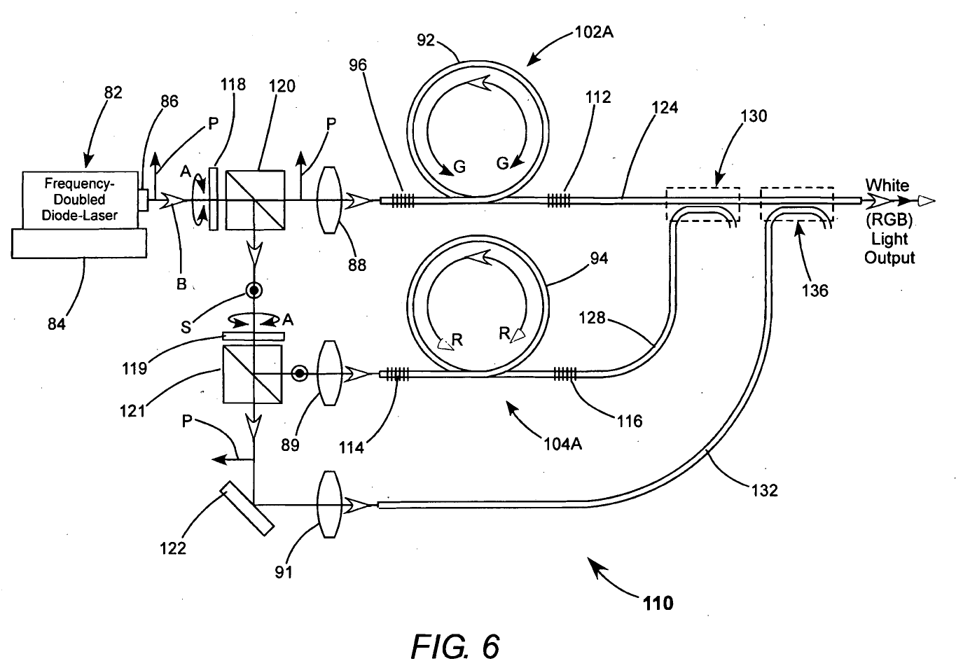

FIG. 6 schematically illustrates still another embodiment 110 of red, green, and blue laser apparatus in accordance with the present invention. Apparatus 110 is similar to apparatus 80 of FIG. 5, with an exception that series connected (fiber connected) fiber laser-resonators 102 and 104 of apparatus 80 are replaced with separate fiber laser-resonators 102A and 104A. Laser-resonator 102A is formed between FBGs 96 and 112. Laser resonator 104A is formed between FBGs 114 and 116. Preferably, as depicted in FIG. 6, laser resonator 102A generates green light and laser resonator 104A generates red light in response to pumping by blue-light. FBG 96 has the same specification discussed above with reference to apparatus 80 of FIG. 5. FBG 96 and all other FBGs have maximum possible transmission for the wavelength of the blue pump light. FBG 112 is partially reflective and partially transmissive for 522 nm-radiation, for example, about 98% reflective and about 2% transmissive. FBG 114 is also maximally reflective for 639 nm-radiation. FBG 116 is partially reflective and partially transmissive for 639 nm-radiation, for example, about 95% reflective and about 5% transmissive.

In apparatus 110, plane-polarized blue light emitted from laser 82 passes through polarization rotator 118 and through a 45°-incidence polarizing beamsplitter 120, here, a bi-prism type beamsplitter. The polarization plane of light leaving the laser is arbitrarily indicated as oriented parallel to the plane of the drawing as indicated by arrow P. The plane of incidence of the polarizing beamsplitter is also parallel to the plane of the drawing. Selectively rotating polarization rotator 118 as indicated by arrow A selectively rotates the polarization plane of blue light incident on the polarizing beamsplitter out of the P orientation. One portion of the blue light is transmitted through polarizing beamsplitter 120 polarized parallel to the plane of the drawing. Another portion of the blue light is reflected from polarizing beamsplitter 120, polarized perpendicular to the plane of the drawing as indicated by arrowhead S.

The portion of light reflected from beamsplitter 120 is passed though another polarization rotator 119 and through another bi-prism type polarizing beamsplitter 121. Selectively rotating polarization rotator 119 as indicated by arrow a selectively rotates the polarization plane of incident on beamsplitter 121 out of the S orientation. One portion of that incident light is transmitted through polarizing beamsplitter 121 polarized parallel to the plane of the drawing. Another portion is reflected by polarizing beamsplitter 121 polarized perpendicular to the plane of the drawing as indicated by arrowhead P.

The P-polarized blue light transmitted by beamsplitter 120 is focused by a lens 88 into fiber laser resonator 102A. Green light output of resonator 102A is transmitted along an output fiber 124. The S-polarized blue light reflected by beamsplitter 121 is focused by a lens 89 into fiber laser resonator 104A. Red light output of resonator is 104A is transmitted along an output fiber 128 and coupled into fiber 124 via a wavelength division multiplexer (WDM) 130. P-polarized blue light transmitted by beamsplitter 121 is directed by a turning mirror 122 to a lens 91 which focuses the light into a fiber 132. The blue light propagates along fiber 132 and is coupled into fiber 124 by another WDM 136. The green light, red light, and blue light are delivered as output from fiber 124.

It should be noted here that fiber 124 is depicted in FIG. 6 as a continuous length of fiber for simplicity of illustration. Practically, WDMs 130 and 136 could be fabricated as separate 4-port units with appropriate ports spliced to short fiber lengths, for example, between WDMs 130 and 136 and following WDM 136 to provide the effected of a continuous fiber 124.

Selectively rotating polarization rotators 118 and 119 can be used to vary the proportions of the blue light delivered to resonators 102A and 104A, and accordingly, to vary proportions of red light, green light, and blue light in the laser output. This is useful either for providing an output of a desired color or for adjusting “white balance” when a neutral white light output is desired, as discussed above. In apparatus 110 it is preferable that for any contemplated proportions of proportions of red light, green light, and blue light in the laser output, all of the blue light injected into resonators 102A and 104A is absorbed in those resonators. This can be accomplished by selecting an appropriate doping of the fiber cores and length of the fiber in loops 92 and 94.

The present invention is described above as a preferred and other embodiments. The invention is not limited, however, to the embodiments described and depicted. Rather, the invention is limited only by the claims appended hereto.

What is claimed is:

1. A method of providing a beam of light having red-light green-light and blue-light components, comprising:
generating a beam of blue light; and
directing said beam of blue light axially and sequentially through first and second laser resonators, each of said resonators including gain medium doped with at least praseodymium, one of said resonators being arranged to deliver green light and the other of said resonators being arranged to deliver red light in response to a first portion of said beam of blue light being absorbed by said gain-media therein, said resonators being arranged such that the beam of light having red-light, green-light, and blue-light components is delivered from said second resonator.

2. The method of claim 1, wherein said blue light has a wavelength which is one of about 440 nm, about 444 nm, about 445 nm, about 451 nm, about 460 nm, about 467 nm, about 468 nm, and about 479 nm, wherein said green light has a wavelength of one of about 522 nm and about 545 nm, and wherein said red light has a wavelength which is one of about 639 and 644 nm.

3. The method of claim 1, wherein each of said laser resonators is fiber laser-resonator including a length of optical fiber between fiber Bragg gratings and said praseodymium-doped gain-medium is a praseodymium-doped core of said optical fiber.

4. The method of claim 1, wherein said gain media are crystal gain-media.

5. The method of claim 4, wherein said praseodymium-doped crystal gain-media are selected from a group of crystal gain media consisting of Pr³⁺:YLF; Pr³⁺:Y₃Al₅O₁₂, Pr³⁺:YAlO₃, Pr³⁺:BaY₂F₈, Pr³⁺:LaF₃, Pr³⁺:CaWO₄, Pr³⁺:SrMoO₄, Pr³⁺:YAG, Pr³⁺:Y₂SiO₅, Pr³⁺:YP₅O₁₄, Pr³⁺:LaP₅O₁₄, Pr³⁺:LuAlO₃, Pr³⁺:LaCl₃, and Pr³⁺:LaBr₃.

6. The method of claim 5, wherein said gain-media are each Pr³⁺:YLF.

7. The method of claim 5, wherein at least one of said praseodymium doped gain-media is co-doped with one or more of erbium, holmium, dysprosium, europium, samarium, promethium, and neodymium.

8. The method of claim 4, wherein said beam of blue light is plane-polarized, and the method further includes the step of selectively orienting the plane of polarization of said blue light with respect to said gain media for selecting specific proportions of said red-light, green light and blue light components in said beam of light delivered from said second resonator.

9. The method of claim 8, wherein said proportions of said components are selected such that said beam of light delivered from said second resonator is a beam of white light.

10. The method of claim 1, wherein said first resonator is arranged to deliver green light and said green light propagates axially through said second resonator together with said blue light.

11. A method of providing a beam of light having red-light green-light and blue-light components, comprising:
generating a beam of blue light; and
directing said beam of blue light axially through first and second resonators in sequence, each of said resonators including a praseodymium-doped crystal gain-medium, said first resonator being arranged to deliver green light in response to a first portion of said blue light being absorbed by said gain-medium therein and said second resonator being arranged to deliver red light in response to a portion of said first residual portion of said blue light being absorbed by said second gain-medium while transmitting said green light and a second residual portion of said blue light, whereby the beam of light having red-light, green-light, and blue-light components is delivered by said second resonator.

12. The method of claim 11, wherein each of said gain-media is Pr³⁺:YLF.

13. The method of claim 11, wherein said each of said laser resonators is formed between mirrors deposited on said crystal gain-medium.

14. Laser apparatus comprising:
a light source arranged to deliver a beam of blue light;
first and second laser resonators each thereof formed between first and second reflectors and having a praseodymium-doped gain-medium disposed between said first and second reflectors;
said laser and said first and second laser-resonators arranged such that said beam of blue light passes sequentially through said first and second laser-resonators with a portion of said blue light being absorbed by each of said gain media and an unabsorbed portion of said blue light being transmitted by said second laser resonator; and
wherein one of said first and second laser resonators is arranged to generate green light in response to said absorption of blue light and the other of said first and second laser resonators is arranged to generate red light in response to said absorption of blue light, and said green and red light is transmitted from said second resonator together with said unabsorbed portion of said blue light.

15. The apparatus of claim 14, wherein said first laser-resonator is arranged to generate green-light.

16. The apparatus of claim 14, wherein said gain media are crystal gain media each thereof having first and second opposite ends and said first and second mirrors of said laser resonators are deposited on first and second opposite ends of said gain-media.

17. The apparatus of claim 14, wherein said gain media are crystal gain media each thereof having first and second opposite ends and said first and second mirrors of said laser resonators are axially spaced apart from said ends of said gain media.

18. The apparatus of claim 14, wherein each of said first and second laser-resonators includes an optical fiber, wherein a length of the core of said optical fiber provides said gain medium, and wherein said second reflectors of each resonator are fiber Bragg gratings written into the core of said optical fiber at opposite ends of the gain-medium-providing length thereof.

19. The apparatus of claim 14, wherein said light source includes one of a frequency-doubled surface-emitting semiconductor laser, a frequency-doubled surface-emitting semiconductor laser, a surface-emitting semiconductor laser delivering fundamental radiation, an edge-emitting semiconductor laser delivering fundamental radiation, and a light-emitting diode.

20. Laser apparatus comprising:
a laser arranged to deliver a beam of plane-polarized blue light;
first and second laser resonators each thereof formed between first and second reflectors and having a praseodymium-doped crystal gain-medium disposed between said first and second reflectors, said crystal gain-medium having a crystal axis;
said laser and said first and second laser-resonators arranged such that said beam of blue light propagated along an optical path sequentially through said first and second laser-resonators, with a first portion of said blue-light beam being absorbed in said gain medium of said first laser-resonator, a second portion of said blue-light beam being absorbed in said gain medium of said second laser-resonator, and an unabsorbed third portion of said blue-light beam being delivered from said second resonator;
said first laser resonator being further arranged to deliver green light in response to said absorption of said first portion of said blue-light beam by said gain medium thereof; and
said second laser resonator being further arranged to deliver red light in response to said absorption of said first portion of said blue-light beam by said gain medium thereof, and to receive, transmit and deliver green-light delivered from said first laser resonator, such that red-light green-light and blue-light are delivered from said second laser-resonator.

21. The apparatus of claim 20, wherein said further including means for selectively adjusting the orientation of the polarization-plane of said blue-light with respect to the crystal axis of at least one of said gain-media.

22. The apparatus of claim 21, wherein said polarization-plane-orientation adjusting means includes a polarization rotator located in the path of the blue-light beam between said laser and said at least one of the gain-media, said polarizer being and selectively rotatable about the path of said blue-light beam.

23. The apparatus of claim 20, wherein at least one of said gain media is selectively rotatable about the path of said blue light beam for selectively adjusting the orientation of the polarization-plane of said blue-light with respect to the crystal axis of said at least one of the gain media.

24. Laser apparatus comprising:
a laser arranged to deliver a first beam of blue-light;
an optical arrangement for dividing said first blue-light beam into second third and fourth blue-light beams;
first and second fiber laser-resonators each thereof including an optical fiber having a praseodymium-doped core;
a first optical arrangement for coupling said second blue-light beam into said first fiber laser-resonator and a second optical arrangement for coupling said third blue-light beam into said second laser resonator;
said first fiber laser-resonator arranged to deliver green light in response to absorption of at least a portion of said second blue-light beam by said praseodymium-doped core of said first fiber laser-resonator; said second fiber laser-resonator arranged to deliver green light in response to absorption of at least a portion of third second blue-light beam by said praseodymium-doped core of said second fiber laser-resonator; and
wherein said green light delivered by said first fiber laser-resonator, said green light delivered by said second fiber laser-resonator, and blue-light from said fourth blue light beam are fiber-coupled into a common output fiber of the appartus.

25. The apparatus of claim 24, further including means for selectively varying proportions of said first blue-light beam in said second third and fourth blue light beams, thereby varying the proportions of red light, green light, and blue light coupled into said common output fiber.

26. The apparatus of claim 24, wherein said first blue-light beam is plane polarized and said selective variation means includes a first polarizing beamsplitter located in said first blue-light beam and a polarization rotator located in said first blue-light beam between said polarizing beamsplitter and the laser.

27. The apparatus of claim 26, wherein said selective-variation means includes a second polarizing beamsplitter located in second first blue-light beam and a second polarization rotator located in said second blue-light beam between said second polarizing beamsplitter and said first polarizing beamsplitter.

28. Laser apparatus; comprising:
a frequency-doubled edge-emitting semiconductor laser; and
a laser resonator including a gain-medium doped with at least praseodymium, said gain medium arranged to be energized by blue light delivered by said frequency-doubled edge-emitting semiconductor laser.

29. The apparatus of claim 28, wherein said gain-medium is a crystal gain-medium.

30. The apparatus of claim 29, wherein the material of said crystal gain-medium is selected from the group of materials consisting of YLF; Y₃Al₅O₁₂, YAlO₃, BaY₂F₈, LaF₃, CaWO₄, SrMoO₄, YAG, Y₂ SiO₅, YP₅O₁₄, LaP₅O₁₄, LuAlO₃, LaCl₃, and LaBr₃.

31. The apparatus of claim 29, wherein said gain-medium is co-doped with one or more of erbium, holmium, dysprosium, europium, samarium, promethium, and neodymium.

32. The apparatus of claim 28, wherein said laser-resonator is a fiber laser-resonator.

33. The apparatus of claim 28, wherein said blue light has a wavelength of about 479 nm.

34. A laser apparatus comprising:
a first laser resonator having a praseodymium doped gain medium and including wavelength selective optics configured such that the resonator will generate green light when the gain medium is optically pumped:
a second laser resonator having a praseodymium doped gain medium and including wavelength selective optics configured such that the resonator will generate red light when the gain medium is optically pumped; and
a source of blue light for optically pumping the first and second laser resonators, said resonators being arranged such that the blue light first enters the first resonator and wherein at least some of the blue light not absorbed therein then passes into the second resonator along with the green light generated by the first resonator and wherein the output of the second resonator includes blue, green and red light.
